(19) United States
(12) Patent Application Publication
(10) Pub. No.: US 2025/0326644 A1
(43) Pub. Date: Oct. 23, 2025

(54) PROCESS FOR PRODUCING GRAPHENE AND/OR GRAPHITE, AND GRAPHENE AND/OR GRAPHITE PREPARED THEREFROM

(71) Applicant: BIO GRAPHENE SOLUTIONS INC., Toronto (CA)

(72) Inventors: Gary VAN DUSEN, Cambridge (CA); Rafaella OLIVEIRA DO NASCIMENTO, Houston, TX (US)

(21) Appl. No.: 18/869,877

(22) PCT Filed: Jun. 2, 2023
(86) PCT No.: PCT/CA2023/050756

§ 371 Date: Nov. 27, 2024

Related U.S. Application Data
(60) Provisional application No. 63/365,739, filed on Jun. 2, 2022.

(51) Int. Cl. C01B 32/184; C01B 32/205

(52) U.S. Cl. CPC C01B 32/184; C01B 32/205; C01B 2204/32; C01P 2002/82; C01P 2002/85; C01P 2002/88; C01P 2004/03; C01P 2004/04

(57) ABSTRACT

The present document relates to a process for the preparation of graphene and/or graphite from a carbon-containing material, the process comprising at least two thermal treatments, the first one being carried at a temperature of 300° C. or below, the second at a temperature of at least 700° C., for instance between 700° C. and 1400° C., wherein the process does not include injection of external hydrogen or an inert gas.

### RELATED APPLICATION

The present application claims priority under applicable law to U.S. provisional application No. 63/365,739 filed on Jun. 2, 2022, the content of which is incorporated herein by reference in its entirety and for all purposes.

### TECHNICAL FIELD

This technology generally relates to methods of producing graphene and/or graphite, for instance, from carbon-containing materials (such as carbohydrate, for instance from biomass, organic or petroleum based oils, wax, alcohols, resins, gums, etc.), to the graphene and/or graphite produced therefrom and to the use thereof.

### BACKGROUND

Graphene is one of the allotropes of carbon, which was initially defined as a single layer of graphite and was obtained by its mechanical exfoliation. Graphene currently rather refers to a class of nanomaterials that includes nanoplatelets, few-layer graphene, single-layer graphene, graphene oxide, reduced graphene oxide, etc.

Many techniques have been developed for the synthesis of graphene, including chemical vapor deposition (CVD), thermal plasma, flash graphene growth, graphene exfoliation, electrochemical exfoliation, micromechanical exfoliation, flash graphene growth, pyrolysis, etc. These techniques may accommodate different source of carbon and may or may not require metals as catalyst. Techniques such as CVD, thermal plasma, and flash graphene growth produce highly crystalline graphene with a single or few layers. However, each of these techniques require a controlled atmosphere and high purity gases including hydrogen, or high voltage discharge that need highly controlled conditions.

Synthetic methods for preparing graphene that use bio-products such as nut shells and carbohydrates either require further chemical treatments to complete the removal of cellulose or combine the carbon source with an inorganic matrix such as silica in various forms including river sand. Additionally, other methods need a chemical pre-treatment of the carbon source, and/or post-treatment of the obtained graphene-like material. The resulting products then resemble graphene/graphite-like materials or a mix of graphene oxide and graphite platelets.

There thus remains a need for the development of alternative processes for producing graphene under conditions applicable to an industrial scale and avoiding one or more of the disadvantages present in other processes.

### SUMMARY

According to one aspect, the present technology relates to a process for producing graphene and/or graphite from a carbon-containing material, as well as the graphene and/or graphite produced therefrom and its uses. More specifically, the following embodiments are provided:

Embodiment 1. Process for the preparation of graphene and/or graphite, said process comprising the steps of:
(a) thermally treating a carbon-containing material at a temperature of at most 300° C.;
(b) thermally treating the product from step (a) at a temperature above 700° C. to induce graphitization and produce a graphitized carbon; and
(c) optionally thermally treating the graphitized carbon from step (b) at a temperature within the range of 200° C. to 600° C. in the presence of air to eliminate residual amorphous carbon;
   wherein said process excludes injection of hydrogen or inert gas.

Embodiment 2. The process of embodiment 1, wherein said carbon-containing material is selected from carbohydrate sources, for instance from biomass, organic or petroleum-based oils, waxes, alcohols, resins, gums, or a combination of two or more thereof.

Embodiment 3. The process of embodiment 2, wherein said carbon-containing material is a carbohydrate source comprising a monosaccharide, disaccharide, oligosaccharide or polysaccharide, or a mixture of two or more thereof.

Embodiment 4. The process of embodiment 3, wherein said carbohydrate source comprises a monosaccharide or disaccharide, or a mixture thereof.

Embodiment 5. The process of embodiment 3, wherein said carbohydrate source comprises an oligosaccharide or polysaccharide, or a mixture thereof.

Embodiment 6. The process of any one of embodiments 3 to 5, wherein said carbohydrate source is fruit peels and processing refuse (e.g. orange peel, pulp, etc.), cereal husks (e.g. rice husks), wood waste, bagasse, wastepaper, recycled cotton fabric, biochar, nut shells, and the like.

Embodiment 7. The process of any one of embodiments 1 to 6, wherein the carbon-containing material further comprises a high carbon material.

Embodiment 8. The process of any one of embodiments 1 to 7, wherein said thermal treatment step (b) is carried out at a temperature within the range of 700° C. to 1400° C.

Embodiment 9. The process of embodiment 8, wherein said thermal treatment step (b) is carried out at a temperature within the range of 800° C. to 1300° C.

Embodiment 10. The process of embodiment 8, wherein said thermal treatment step (b) is carried out at a temperature within the range of 900° C. to 1200° C.

Embodiment 11. The process of embodiment 8, wherein said thermal treatment step (b) is carried out at a temperature within the range of 950° C. to 1100° C., e.g. about 1050° C.

Embodiment 12. The process of any one of embodiments 1 to 11, wherein said process further comprises an intermediate thermal treatment carried out at a temperature within the range of 400° C. to 700° C. between steps (a) and (b).

Embodiment 13. The process of embodiment 12, wherein said intermediate thermal treatment is carried out at a temperature within the range of 500° C. to 650° C.

Embodiment 14. The process of embodiment 12, wherein said intermediate thermal treatment is carried out at a temperature within the range of 500° C. to 600° C.

Embodiment 15. The process of any one of embodiments 1 to 14, wherein said process further comprises a micronizing before step (b).

Embodiment 16. The process of any one of embodiments 1 to 15, wherein said thermal treatment step (b) is carried out under an atmosphere comprising air (e.g., restricted air).

Embodiment 17. The process of any one of embodiments 1 to 16, wherein said thermal treatment step (b) is carried out in a covered vessel (e.g. including a lid) wherein said covered vessel is not sealed or wherein said covered vessel is sealed and includes pressure release valves or pressure control means, preferably the covered vessel is not sealed.

Embodiment 18. The process of any one of embodiments 1 to 17, wherein said thermal treatment step (b) comprises in situ generation of hydrogen (H₂).

Embodiment 19. The process of any one of embodiments 1 to 18, wherein said process excludes the addition of a single metal, metal oxide, alloys, and the like.

Embodiment 20. The process of any one of embodiments 1 to 18, wherein said step (a) and/or (b) further comprise the addition of single metals, salt-derivate metals, metal oxides, alloys, metal nanostructures.

Embodiment 21. The process of any one or embodiments 1 to 20, wherein said step (a) is carried out at a temperature within the range of 150° C. to 300° C., preferably 200° C. to 300° C., more preferably 200° C. to 250° C.

Embodiment 22. The process of any one or embodiments 1 to 21, wherein the carbon-containing material comprises a carbohydrate source and said thermal treatment of step (a) comprises drying the carbohydrate source and/or breaking of di-, oligo- and/or polysaccharide chains from the carbohydrate source.

Embodiment 23. The process of any one of embodiments 1 to 22, wherein said step (a) is carried out under an atmosphere comprising air.

Embodiment 24. The process of any one of embodiments 1 to 23, wherein said thermal treatment of step (c) is present.

Embodiment 25. The process of embodiment 24, wherein said thermal treatment of step (c) is carried out at a temperature within the range of 200° C. to 350° C.

Embodiment 26. The process of any one of embodiments 1 to 25, wherein said content of residual amorphous carbon in the graphitized carbon is less than 5 wt. %, or less than 2 wt. %, or less than 1 wt. % after step (b).

Embodiment 27. The process of any one of embodiments 1 to 26, wherein said process further comprises micronizing the graphene and/or graphite after step (b) and/or after step (c) if present.

Embodiment 28. The process of any one of embodiments 1 to 27, wherein said process comprises a carbon conversion from the carbon-containing material to graphene and/or graphite of at least 30 mol %, at least 40 mol %, or at least 50 mol %.

Embodiment 29. The process of any one of embodiments 1 to 28, wherein said graphene has an average particle size or flake length below 20 nm, or between about 0.1 nm and about 10 nm, or between about 1 and about 10 nm, or between about 2 nm and about 5 nm.

Embodiment 30. The process of any one of embodiments 1 to 29, wherein said graphene has a structure comprising nanoflakes, nanoplatelets, carbon shells, or a combination thereof, preferably comprising nanoflakes or nanoplatelets.

Embodiment 31. The process of any one of embodiments 1 to 30, wherein said graphene has a structure comprising nanocones, nanohorns, nanodandelions, nanoribbons, nanopetals, or a combination thereof.

Embodiment 32. The process of any one of embodiments 1 to 31, wherein said graphite is synthetic graphite having a structure comprising synthetic graphite platelets or nanoplatelets.

Embodiment 33. The process of any one of embodiments 1 to 32, wherein said graphene comprises monolayer graphene, few-layer graphene (2 to 20 layers), or a combination thereof.

Embodiment 34. The process of any one of embodiments 1 to 33, wherein said graphene comprises graphene of turbostratic nature.

Embodiment 35. The process of any one of embodiments 1 to 34, wherein said graphene and/or graphite has a carbon content of at least 80 mol %, at least 90 mol %, at least 95 mol %, or at least 97 mol %, or at least 98 mol %, or at least 99 mol %.

Embodiment 36. The process of any one of embodiments 1 to 33, wherein said graphene and/or graphite has a content in Cd and/or Co of less than 0.1 ppm, and/or a content in As and/or Pb of less than 0.5 ppm, and/or a content in Al, Ca, Cr, K, Mn, Na, P and/or Ti of less than 100 ppm, preferably less than 50 ppm, each obtained by elemental analysis of the graphene and/or graphite.

Embodiment 37. The process of any one of embodiments 1 to 34, wherein said graphene and/or graphite has a content in Cd, Co, Cr, and/or Zr of less than 0.1 ppm, and/or a content in As and/or Pb of less than 0.5 ppm, and/or a content in Al, Fe, K, Mn, P and/or Ti of less than 10 ppm, and/or a content in C and/or Na of less than 50 ppm, each obtained by elemental analysis of the graphene and/or graphite.

Embodiment 38. Graphene and/or graphite prepared by a process as defined in any one of embodiments 1 to 37.

Embodiment 39. Graphene and/or graphite comprising a carbon content of at least 95 mol %, or at least 97 mol %, or at least 98 mol %, or at least 99 mol %.

Embodiment 40. The graphene and/or graphite of embodiment 39, wherein said graphene has a structure comprising nanoflakes, nanoplatelets, carbon shells, or a combination thereof.

Embodiment 41. The graphene and/or graphite of embodiment 39 or 40, wherein said graphene has a structure comprising nanocones, nanohorns, nanodandelions, nanoribbons, nanopetals, or a combination thereof.

Embodiment 42. The graphene and/or graphite of any one of embodiments 39 to 41, wherein said graphite is synthetic graphite having a structure comprising synthetic graphite platelets or nanoplatelets.

Embodiment 43. The graphene and/or graphite of any one of embodiments 39 to 42, wherein said graphene has an average length below 20 nm, or between about 0.1 nm and about 10 nm, or between about 1 and about 10 nm, or between about 2 nm and about 5 nm.

Embodiment 44. The graphene and/or graphite of any one of embodiments 39 to 43, wherein said graphene comprises monolayer graphene, few-layer graphene (2 to 20 layers), or a combination thereof.

Embodiment 45. The graphene and/or graphite of any one of embodiments 39 to 43, wherein said graphene is at least in part of turbostratic nature.

Embodiment 46. The graphene and/or graphite of any one of embodiments 39 to 45, wherein said graphene and/or graphite has a content in Cd and/or Co of less than 0.1 ppm, and/or a content in As and/or Pb of less than 0.5 ppm, and/or a content in Al, Ca, Cr, K, Mn, Na, P and/or Ti of less than 100 ppm, preferably less than 50 ppm, each obtained by elemental analysis of the graphene and/or graphite.

Embodiment 47. The graphene and/or graphite of any one of embodiments 39 to 46, wherein said graphene and/or graphite has a content in Cd, Co, Cr, and/or Zr of less than 0.1 ppm, and/or a content in As and/or Pb of less than 0.5 ppm, and/or a content in Al, Fe, K, Mn, P and/or Ti of less than 10 ppm, and/or a content in C and/or Na of less than 50 ppm, each obtained by elemental analysis of the graphene and/or graphite.

Additional objects and features of the present compound, compositions, methods and uses will become more apparent upon reading of the following non-restrictive description of exemplary embodiments and examples section, which should not be interpreted as limiting the scope of the invention.

### BRIEF DESCRIPTION OF THE FIGURES

FIGS. 1(a) to 1(c) are schematic representations illustrating embodiments of the present method of producing graphene from a carbohydrate-containing materials, each scheme containing three possible heating zones in various configurations.

FIGS. 2(a) to 2(j) show transmission electron microscopy (TEM) images at various resolution as described in Example 3(i) of a graphene G-1 sample prepared as in Example 2.

FIGS. 3(a) to 3(h) show TEM images at various resolution as described in Example 3(i) of a graphene G-2 sample prepared as in Example 2.

FIGS. 4(a) to 4(f) show scanning electron microscopy (SEM) images at various resolution as described in Example 3(ii) of a graphene G-3 sample prepared as in Example 2.

FIGS. 5(a) to 5(d) show SEM images at various resolution as described in Example 3(ii) of a graphene G-4 sample as described in Example 2.

FIGS. 6(a) to 6(d) show SEM images: (a) and (b) at various resolution as described in Example 3(ii) of graphene G-5 sample prepared as in Example 2; and (c) and (d) at high resolution as described in Example 3(ii) of a graphene G-3 sample prepared as in Example 2.

FIG. 7 shows an energy dispersive X-ray spectroscopy (EDS) spectrum (top), and SEM images and mapping (carbon, oxygen, iron) as described in Example 3(ii) of a graphene G-6 sample prepared as in Example 2.

FIG. 8 shows an energy dispersive X-ray spectroscopy (EDS) spectrum (top), and SEM images and mapping (carbon, oxygen, iron) as described in Example 3(ii) of a graphene G-7 sample prepared as in Example 2.

FIG. 9 shows an energy dispersive X-ray spectroscopy (EDS) spectrum (top), and SEM images and mapping (carbon, oxygen) as described in Example 3(ii) of a graphene G-5 sample prepared as in Example 2.

FIGS. 10(a) and 10(b) present the thermal gravimetric analysis (TGA) as described in Example 3(iii) of graphene G-8 samples prepared as in Example 2.

FIG. 11 shows a Raman spectrum as described in Example 3(iv) of graphene G-8 samples prepared as in Example 2.

### DETAILED DESCRIPTION

All technical and scientific terms and expressions used herein have the same definitions as those commonly understood by a person skilled in the art to which the present technology pertains. The definition of some terms and expressions used is nevertheless provided below. To the extent the definitions of terms in the publications, patents, and patent applications incorporated herein by reference are contrary to the definitions set forth in this specification, the definitions in this specification will control. The section headings used herein are for organizational purposes only and are not to be construed as limiting the subject matter disclosed.

The terminology used herein is for the purpose of describing particular embodiments only and is not intended to be limiting. It should be noted that, the singular forms “a”, “an”, and “the” include plural forms as well, unless the content clearly dictates otherwise. Thus, for example, reference to a composition containing “a compound” also contemplates a mixture of two or more compounds. It should also be noted that the term “or” is generally employed in its sense including “and/or” unless the context clearly dictates otherwise. Furthermore, to the extent that the terms “including”, “includes”, “having”, “has”, “with”, or variants thereof are used in either the detailed description and/or the claims, such terms are intended to be inclusive in a manner similar to the term “comprising”.

The term “about” or “approximately” means within an acceptable error range for the particular value as determined by one of ordinary skill in the art, which will depend in part on how the value is measured or determined, i.e., the limitations of the measurement system. For example, “about” can mean within one or more than one standard deviation, as per the practice in the art. Alternatively, “about” can mean a range of up to 20%, preferably up to 10%, more preferably up to 5%, and more preferably still up to 1% of a given value. Where particular values are described in the application and claims, unless otherwise stated the term “about” meaning within an acceptable error range for the particular value should be assumed.

The terms “graphene”, “graphite”, and “graphene and/or graphite” as used herein refers to synthetic materials generally recognized as being composed of layers of trigonal planar carbon in the form of a honeycomb lattice. Graphite (here synthetic graphite) includes multiple layers of this lattice, whereas graphene is generally understood to include fewer layers (e.g. 20 or less, or 10 or less). It should be understood that these terms also encompass graphene and/or graphite derivatives such as surface functionalized graphene and/or graphite, graphene and/or graphite oxides, reduced graphene and/or graphite oxides, and/or as including other carbon forms in combination with the graphene and/or graphite or derivatives thereof. In some instances, the term graphene and/or graphite may also exclude graphene and/or graphite derivatives.

The expression “carbon-containing source”, “carbon source”, “carbon-containing material” and equivalent expressions refer to a material containing carbon atoms in a proportion sufficient to produce a graphitization of the material upon thermal treatment (but excluding an already graphitized product). Examples of carbon-containing materials include a carbohydrate-containing material, for instance from biomass, organic or petroleum-based oils, wax, alcohols, resins, gums, or a combination of two or more thereof.

The expressions “carbohydrate source”, “carbohydrate-containing material” or other equivalent expressions as used herein include any source or material comprising a carbohydrate (such as a sugar, starch and/or cellulose), and which may further comprise other materials, such as a material having a high carbon content (high carbon source). Non-limiting examples of carbohydrates include monosaccharides, disaccharides, oligosaccharides and polysaccharides, such as glycosaminoglycans, cellulose, starch (amylose, amylopectin), chitin, chitosan, inulin, cyclodextrin, and the like, and materials comprising them such as fruit peels and processing refuse (e.g. orange peel, pulp, etc.), cereal husks (e.g. rice husks), wood waste, bagasse, wastepaper, recycled cotton fabric, biochar, nut shells, and the like.

Non-limiting examples of wax include beeswax, carnauba wax, paraffin wax, soy wax, etc. Examples of gums include, without limitations, arabic gum, xanthan gum, cashew gum, guar gum, etc. Oils can be, for instance, from petroleum byproducts or be natural oils obtained from natural sources such as almonds, soya, canola, corn, cotton seed, grape seed, avocado oil, etc.

As used herein, the expression “restricted air” or “low air” as used herein when referring to thermal treatment conditions means an atmosphere which contains air naturally present (e.g. rather than added as a gas stream) upon closing a lid or covering a heating vessel. During the thermal treatment, this atmosphere will likely contain other gas generated during the thermal treatment, such as hydrogen gas generated in situ.

The present technology applies a modified pyrolysis method to obtain graphene and/or graphite originating from bio-sources or from their waste. Orange peel, rice husk, wood waste, saccharides, bagasse, waste newspaper, wastepaper, recycled cotton fabric, biochar, and nut shells, are but a few examples of carbon sources that can be used in combination or individually to produce graphene and/or graphite using the present process.

The present process does not require the addition of metals. However, it allows the optional application of single metals, salt-derivate metals, metal oxides, alloys, metal nanostructures or a combination thereof in some variations of the process.

While, as mentioned above, previous techniques require either a controlled atmosphere and high purity gases including hydrogen, or high voltage discharge that need highly controlled conditions, the present process does not require any of these controlled conditions. In fact, the synthesis of graphene and/or graphite in the present process may even occur under low air conditions.

Furthermore, the present process generally does not require further treatment such as a chemical pre-treatment of the carbon source and/or a chemical post-treatment of the obtained graphene and/or graphite. Accordingly, since the present method does not generally apply any harsh chemical conditions such as acids, bases, or organic solvents during the synthesis or to pre-treat the carbon source or its final product, the present method may be considered as eco-friendly and a cleantech. The method is also applicable to a one-pot synthesis setting.

More specifically, the present document therefore relates to a process for the preparation of graphene and/or graphite, said process comprising at least the steps of:
(a) thermally treating a carbon-containing material at a temperature of at most 300° C.;
(b) thermally treating the product of step (a) at a temperature above 700° C. to induce graphitization to produce a graphitized carbon; and
(c) optionally thermally treating the graphitized carbon from step (b) at a temperature within the range of 200° C. to 600° C. in the presence of air to eliminate residual amorphous carbon;
   wherein the process excludes injection of hydrogen gas or inert gas.

In some examples, the carbon-containing material is selected from carbohydrate sources, for instance from biomass, organic or petroleum-based oils, waxes, alcohols, resins, gums, or a combination of two or more thereof.

For instance, the carbon-containing material may be a carbohydrate source comprising a monosaccharide, disaccharide, oligosaccharide or polysaccharide, or a mixture of two or more thereof. In another embodiment, the carbohydrate source comprises a monosaccharide or disaccharide, or a mixture thereof. In a further embodiment, the carbohydrate source comprises an oligosaccharide or polysaccharide, or a mixture thereof. In yet another embodiment, the carbohydrate source is fruit peels and processing refuse (e.g. orange peel, pulp, etc.), cereal husks (e.g. rice husks), wood waste, bagasse, wastepaper, recycled cotton fabric, biochar, nut shells, and the like.

In other examples, the carbon-containing material may also further comprise a high carbon material. For instance, the high carbon material is present in less than 50 wt. % of the total carbon-containing material, or less than 40 wt. %, or less than 30 wt. %, or less than 20 wt. %.

Treatment step (b) is preferably carried out under an atmosphere containing air, such as restricted air as defined herein, under normal atmospheric pressure or near normal atmospheric pressure. However, the presence of an inert gas is generally not necessary in the present process. The air present in the vessel is generally ambient from the vessel. The present process does not usually necessitate a flow of gas (air or other) passing through the vessel. For instance, thermal treatment step (b) is carried out in the presence of hydrogen which is generated in situ during the thermal treatment rather than by injection. Thermal treatment step (b) may generally be carried out in a covered vessel, for instance, in a reaction vessel comprising a lid although the lid is preferably not sealed to avoid risks of explosion. If the covered vessel is a sealed vessel, then it can include pressure release valves or other pressure control means. Preferably, the covered vessel is not sealed and allows small gas exchanges with its immediate environment.

The vessel may be in an oven, such as a tubular oven with or without various heating zones, or other types of oven system such as calciners, muffle furnaces, etc. The vessel may be any reaction container (such as, but not limited to, a crucible, tray, tube, etc.) that can withstand the reaction conditions without degradation and without significantly contaminating the material being treated.

The thermal treatment of step (b) comprises at least one step carried out at a temperature above 500° C., for instance within the range of 700° C. and 1400° C., or 900° C. to 1300° C., or 900° C. to 1200° C., or 950° C. to 1100° C., or of about 1050° C.

In some examples, the process further comprises an intermediate thermal treatment carried out at a temperature within the range of 400° C. to 700° C. between steps (a) and (b). In a preferred example, the intermediate thermal treatment is carried out at a temperature within the range of 500° C. to 650° C., or within the range of 500° C. to 600° C., or within the range of 550° C. to 580° C., or about 565° C.

In some cases, the process may further comprise a step of micronizing the material before step (b). Alternatively or in combination, the process may also further comprise micronizing the graphene and/or graphite after step (b) and/or after step (c) if present. Micronization may be carried out by any conventional method, including, but not limited to, grinding, milling, pulverization, such as ball-milling, ring and puck grinding, pestle and mortar grinding, jet pulverizing, jet milling, roll mills, and other wet or dry micronization techniques, etc.

The present process does not usually require addition of a metal catalyst. In some cases, however, the process may be adapted to further comprise the addition of single metals, salt-derivate metals, metal oxides, alloys, metal nanostructures at step (a) and/or (b). The present process may further be adjusted to obtain hetero-nanostructures which may be directly produced by adding other nanomaterials (e.g. 2D materials) mixed or not with the carbon source or by co-growth (or co-synthesis) by adding the chemical precursors of the other nanomaterials.

In some examples of the present process, step (a) is carried out at a temperature within the range of 150° C. to 300° C., preferably 200° C. to 300° C., more preferably 200° C. to 250° C. In some cases, when the carbon-containing material comprises a carbohydrate source, then such a thermal treatment of step (a) may also further comprise breaking di-, oligo- and/or polysaccharide chains from the carbohydrate. Step (a) may be carried out in the presence of air, e.g., ambient air.

In various examples, step (c) comprising a thermal treatment to eliminate residual amorphous carbon is carried out if such residual amorphous carbon is present. For example, step (c) may be included when the product obtained after step (b) comprises more than 10% by weight, or more than 5% by weight, or more than 3% by weight of residual amorphous carbon. For instance, such a thermal treatment may be carried out at a temperature within the range of 200° C. to 350° C.

In preferred embodiments, the content of residual amorphous carbon in the graphitized carbon is less than 5 wt. %, or less than 2 wt. %, or less than 1 wt. % after step (b).

The graphene and/or graphite is preferably produced by the present process through a carbon conversion rate from the carbon-containing material to graphene and/or graphite of at least 30 mol %, at least 40 mol %, or at least 50 mol %, or even more.

In preferred examples, the graphene produced has an average particle size or flake length below 20 nm, or between about 0.1 nm and about 10 nm, or between about 1 and about 10 nm, or between about 2 nm and about 5 nm. The structure of the graphene may also include one or more of nanoflakes, nanoplatelets, carbon shells, and other similar. Alternatively, the structure of the graphene may also include one or more of nanocones, nanohorns, nanodandelions, nanoribbons, nanopetals, and other similar.

The graphene may include monolayer graphene, few-layer graphene (2 to 20 layers) such as graphene nanoplatelets, or a combination thereof. In some examples, the graphene is at least partly of turbostratic nature, for instance with various types of stacking.

The graphite is synthetic graphite having more than 20 layers of carbon lattice, preferably the graphite is synthetic graphite having a structure comprising synthetic graphite platelets or nanoplatelets.

The graphene and/or graphite produced by the present process preferably has a carbon content of at least 80 mol %, at least 90 mol %, at least 95 mol %, or at least 97 mol %, preferably at least 98 mol %, or even at least 99 mol %.

According to certain examples, the graphene and/or graphite has a content in Cd and/or Co of less than 0.1 ppm, and/or a content in As and/or Pb of less than 0.5 ppm, and/or a content in Al, Ca, Cr, K, Mn, Na, P and/or Ti of less than 100 ppm, preferably less than 50 ppm, each obtained by elemental analysis of the graphene and/or graphite. Alternatively, the graphene and/or graphite has a content in Cd, Co, Cr, and/or Zr of less than 0.1 ppm, and/or a content in As and/or Pb of less than 0.5 ppm, and/or a content in Al, Fe, K, Mn, P and/or Ti of less than 10 ppm, and/or a content in C and/or Na of less than 50 ppm, each obtained by elemental analysis of the graphene and/or graphite.

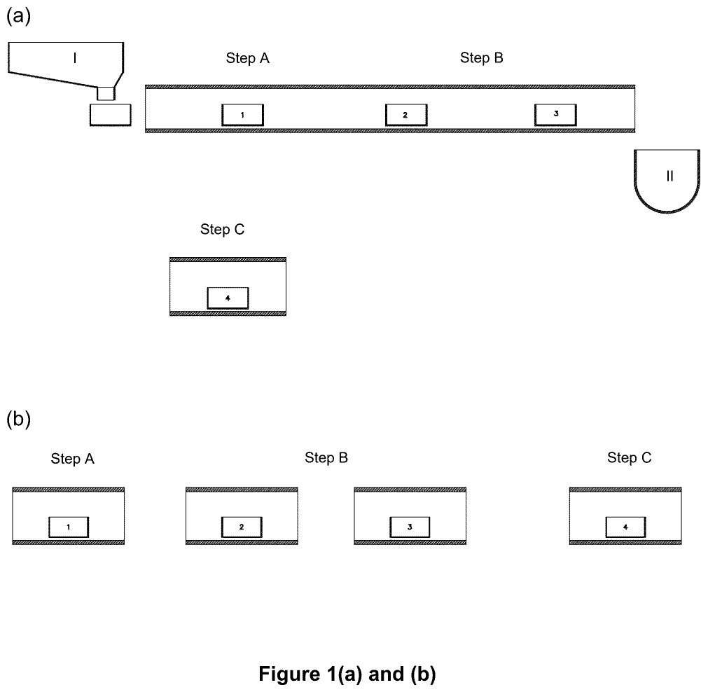

Possible embodiments of the present process are illustrated in FIGS. 1(a) to 1(c), each schematically illustrate one possible manner in which the present process may be carried out. In these embodiments, up to four thermal treatment zones (1), (2), (3), and (4) represent respectively the thermal treatment of step (a), the intermediate thermal treatment, the thermal treatment of step (b), and optional thermal treatment step (c), each being as defined above. It should be noted that, in FIGS. 1(a) to 1(c), the intermediate thermal treatment and thermal treatment step (b) both appear under Step B, while thermal treatment steps (a) and (c) correspond to Steps A and C, respectively. At least one loading stage (I) where the starting material is loaded to the system and at least one recovery stage (II) when the treated material is recovered are also shown in each scheme. In FIG. 1(a), the first three heating zones are located within an apparatus allowing for multiple thermal zones (such as a tubular furnace). The fourth heating zone is included in a separate oven in which the optional thermal treatment Step C is carried out after recovery in II. In FIG. 1(b), each of the four heating zones may be within the same oven, in which the temperature is adjusted for each step. In FIG. 1(c), thermal treatment zones are located in different ovens in which the thermal treatment temperature in adjusted for the specific step, each step being preceded by a loading stage (I) and followed by a recovery stage. For instance, in FIG. 1(c), the carbon-containing starting material is loaded in stage (I) of thermal treatment zone (1). The material which has undergone the first heat treatment is then recovered in stage (II) and loaded again in a new oven for thermal treatment (2) and so on, until the graphene and/or graphite is recovered in stage (II) of thermal treatment zone (4) after Step C. As mentioned herein, one or more of the thermal treatment zones (2) and (4) may be omitted in some embodiments of the present process. Micronization steps may also be included after Step B, or C if present, of each of these embodiments, or between thermal treatment zones (2) and (3) when zone (2) is present.

In sum, the present generally includes synthesis of graphene and/or graphite from organic carbon sources, whether waste-derived or not, in ambient air conditions, i.e. without an additional gas flow, and without the use of a sealed or inert environment. The graphene flakes produced are generally of short length and a small number of layers. The method is cost effective and may be applied to a single source of carbon or to multiple carbon sources.

The present method also allows synthesis in a tubular oven with or without various heating zones. Alternatively, a combination of calciners, muffle furnaces, or other types of ovens, would also be sufficient to prepare the graphene and/or graphite using the present process. Moreover, any other heating oven/device that simulates the conditions of the present synthetic method can be used to prepare the graphene and/or graphite and could even be applied to produce any graphene-like and/or graphite-like or carbon-nanostructure materials.

Graphene and/or graphite prepared by the present method may be used in a broad variety of known graphene and/or graphite applications, for instance, as additives in concrete, asphalt, composites, anti-corrosion coatings and paints, 3D printing, electrodes, solar panels, flexible panels, thermal foils, sensors, quantum computing, heteronanostructures, new generation of metal-organic framework (MOF) and covalent organic framework (COF), water and gas filtration systems, optical sensors, smart glass, stray light reducing black coatings, etc.

The recitation of an embodiment or example for a variable herein includes that embodiment or example as a single embodiment or example or in combination with any other embodiments, examples or portions thereof. The recitation of an embodiment herein includes that embodiment as any single embodiment or in combination with any other embodiments or portions thereof.

### EXAMPLES

The following non-limiting examples are illustrative embodiments and should not be construed as further limiting the scope of the present invention. These examples will be better understood with reference to the accompanying figures.

Unless otherwise indicated, all numbers expressing quantities of ingredients, reaction conditions, concentrations, properties, stabilities, and so forth used in the specification and claims are to be understood as being modified in all instances by the term “about.” At the very least, each numerical parameter should at least be construed in light of the number of reported significant digits and by applying ordinary rounding techniques. Accordingly, unless indicated to the contrary, the numerical parameters set forth in the present specification and attached claims are approximations that may vary depending upon the properties sought to be obtained. Notwithstanding that the numerical ranges and parameters setting forth the broad scope of the embodiments are approximations, the numerical values set forth in the specific examples are reported as precisely as possible. Any numerical value, however, inherently contain certain errors resulting from variations in experiments, testing measurements, statistical analyses and such.

### Example 1—General Method

The modified pyrolysis was achieved through a feed-stock side, heating area that can be subdivided or not into various heating zones, with or without inert gas or any reducing gas or agent. This technique is robust to produce the nanomaterials even in a reduced air atmosphere. Additionally, the morphology of the nanomaterials is modified with residence time, presence or absence of metal traces and its products, and the application of micro or nanostructures.

Generally, an organic powder source of carbon such as dried beeswax or a source of saccharide (at least 100 g to 1000 g) is placed in a container, following by a heat treatment at lower temperature (e.g. between 200° C. and 300° C.) during at least 60 minutes under air. Following this step, the material is placed into a vessel/tray (e.g., crucibles, etc.), covered with a lid (but not sealed) and treated at high temperatures (e.g. between 900° C. to 1200° C.), in the presence of air (naturally present in the vessel/tray/tube), during 15 minutes to 240 minutes. During this step, there is in situ generation of hydrogen. Subsequently, during the cooling stage, the material is kept undisturbed until it reaches room temperature or a temperature cold enough for handling. Then, the material may be further treated at a lower temperature (about 300° C.) under air to eliminate residual amorphous carbon if present. This last step may be avoided if the amorphous content is below 5% to 10%. Subsequently, the material obtained may be micronized using any compatible available method to obtain a final sample.

Variation on this process included inert gas (e.g., nitrogen or argon) vs air atmosphere, and an additional thermal treatment between the first lower temperature and high temperature and carried out at temperatures, for instance ranging from 450° C. to 690° C., under air. The obtained sample may also be micronized before being treated at the higher temperature.

### Example 2—Preparation of Graphene

The present example describes the synthetic method used for preparing the graphene samples used for further analysis in Example 3.

An organic powder of saccharide (1000 g) was placed in a container and thermally treated at a temperature T₁ during at least 60 minutes under ambient air. Then, the material was placed into crucibles and covered with a lid. The material was optionally treated at a temperature T₂, followed by an optional micronization M₁ step, and a thermal treatment at a temperature T₃, under air from the crucibles (no gas flow), for 60 minutes. During this step, hydrogen was self-generated in situ into the crucible. Subsequently, the material was kept undisturbed until the material reached room temperature, or cold enough for handling (cooling stage). The graphene material obtained may also be micronized in a M₂ step.

A range of conditions were tested, some of which are presented herein. The conditions used for preparing each of samples G-1 to G-10 analyzed in Example 3 are summarized in Table 1.

TABLE 1
Preparation conditions for samples G-1 to G-10

| Sample | T₁ | T₂ | M₁^{a} | T₃ | M₂^{a} |
|---|---|---|---|---|---|
| G-1 | 220° C. | — | — | 1050° C. | — |
| G-2 | 220° C. | 550° C. | BM | 1050° C. | — |
| G-3 | 220° C. | 550° C. | BM | 1050° C. | BM |
| G-4 | 220° C. | 550° C. | FM | 1050° C. | — |
| G-5 | 220° C. | — | — | 1050° C. | FM |
| G-6 | 220° C. | — | — | 1050° C. | BM |
| G-7 | 220° C. | 565° C. | FM | 1050° C. | — |
| G-8 | 220° C. | 550° C. | BM | 1050° C. | FM |
| G-9 | 220° C. | 565° C. | PM | 1050° C. | PM |
| G-10 | 220° C. | 565° C. | FM | 1050° C. | BM |

^{a}BM: ball milling in a zirconia coated jar with zirconia balls for about 1 to 4 hours; FM: fast milling (5 minutes) with a ring and puck grinding apparatus; and PM: grinding using a glass pestle and mortar.

### Example 3—Characterization

Graphene samples prepared using the present process were analyzed by various methods. The following summarize part of the results obtained.

### (i) Transmission Electron Microscopy (TEM):

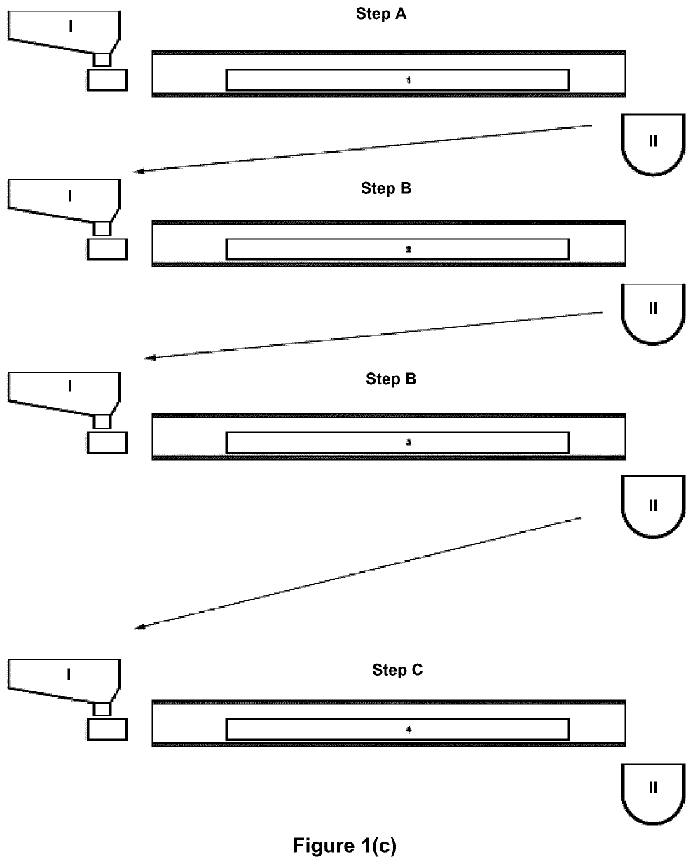

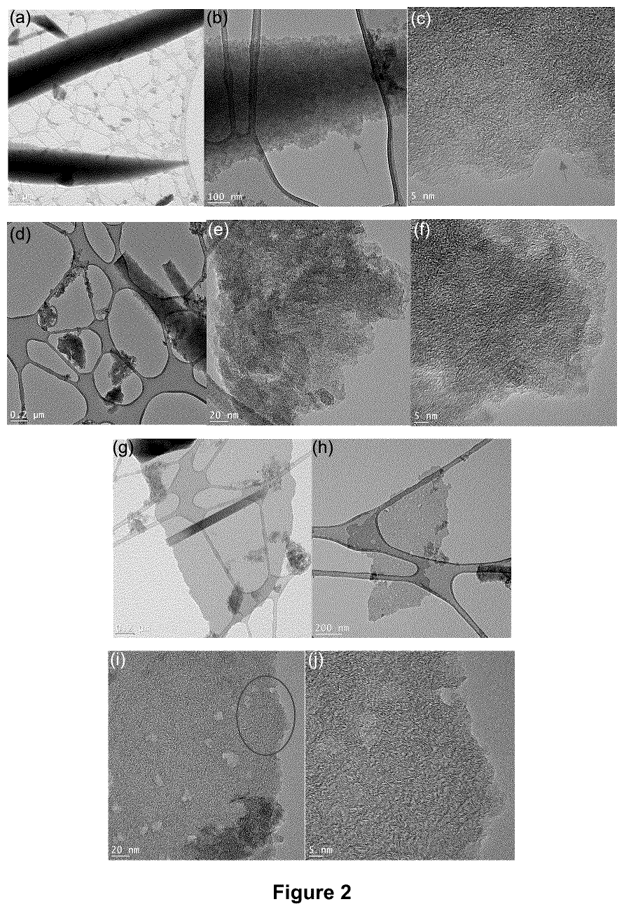

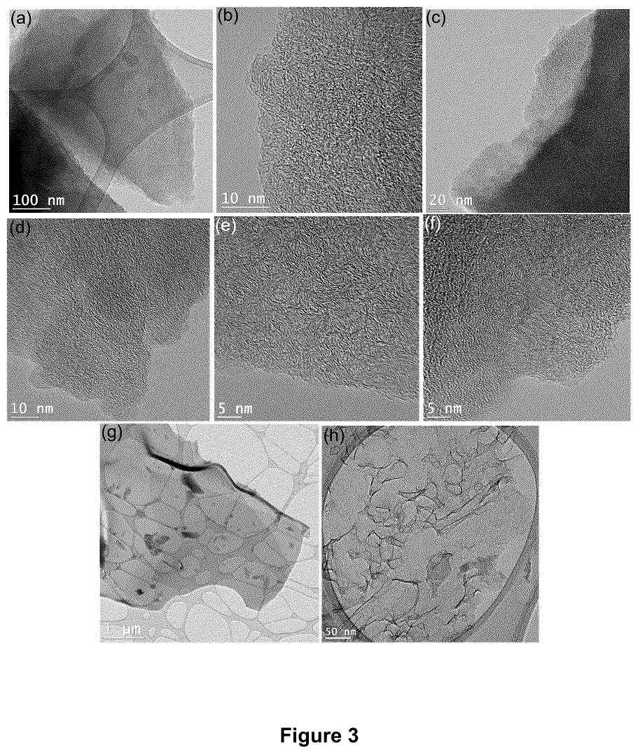

TEM images were obtained at various resolutions for samples G-1, G-2 and G-3 as prepared in Example 2. FIGS. 2(a) to 2(j) show images obtained for sample G-1. FIGS. 3(a) to 3(h) present the TEM images for sample G-2. As can be seen especially on the higher resolution images of FIGS. 2(c), 2(f), 2(j), 3(e), and 3(f), the graphene flakes generally include up to 5 layers. The layers stacking would also likely correspond to a mainly turbostratic arrangement.

### (ii) Scanning Electron Microscopy (SEM) Images and Mapping Images:

SEM images and mapping were also obtained for samples prepared using the present method. Energy dispersive X-ray spectroscopy (EDS) spectra were also measured for some of the samples.

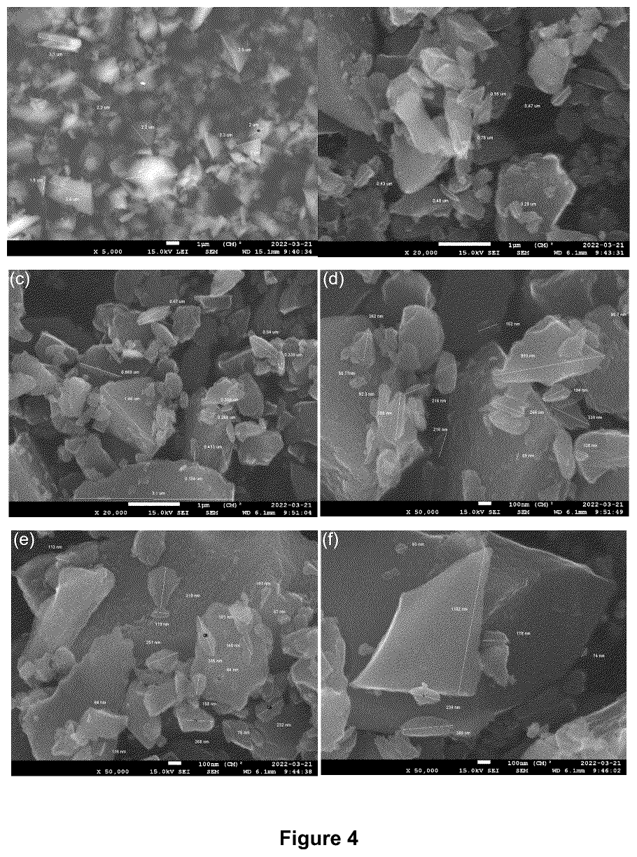

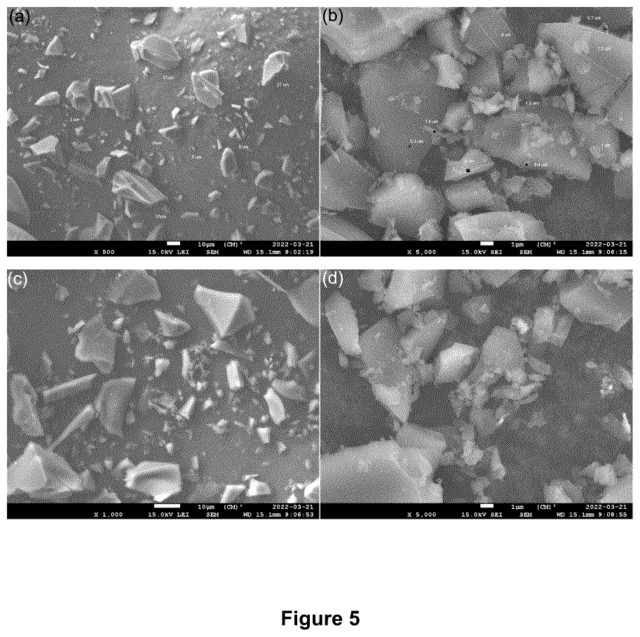

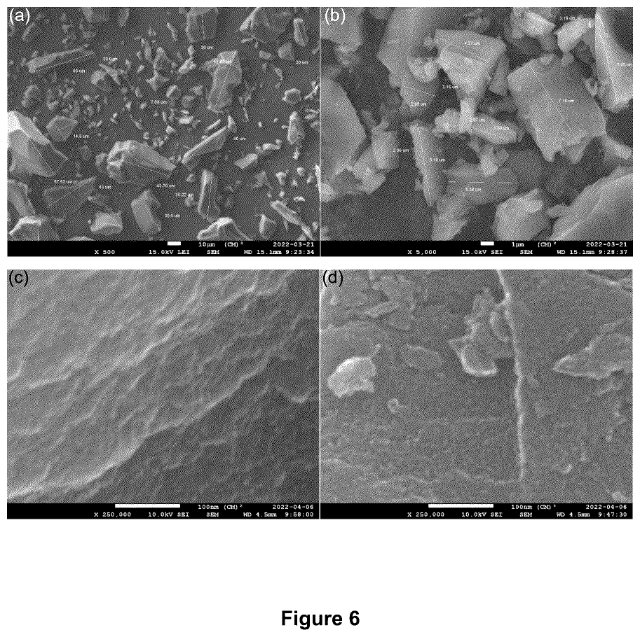

SEM images of sample G-3 taken at ×5000, ×20,000, and ×50,000 magnifications are shown in FIGS. 4(a) to 4(f) and at ×250,000 in FIGS. 6(c) and 6(d). FIGS. 5(a) to 5(d) present SEM images at ×500, ×1000 and ×5000 magnifications for sample G-4. SEM images of sample G-5 taken at ×500 and ×5000 magnifications are also shown in FIGS. 6(a) and 6(b).

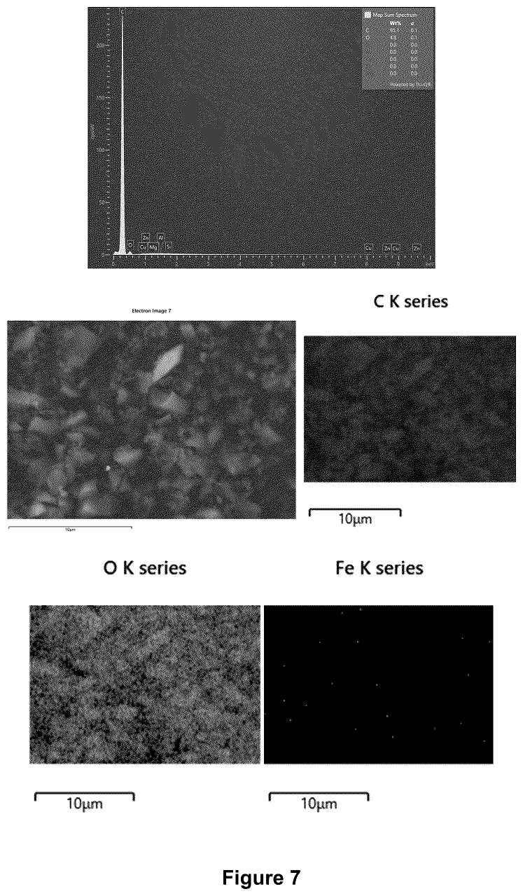

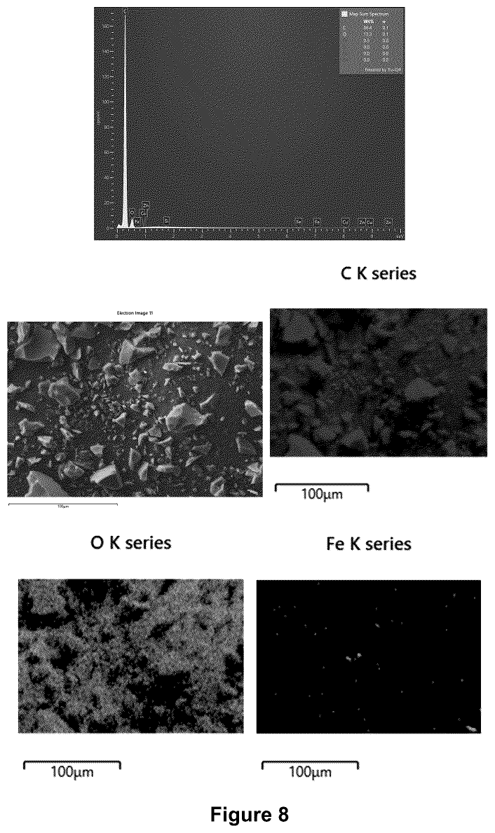

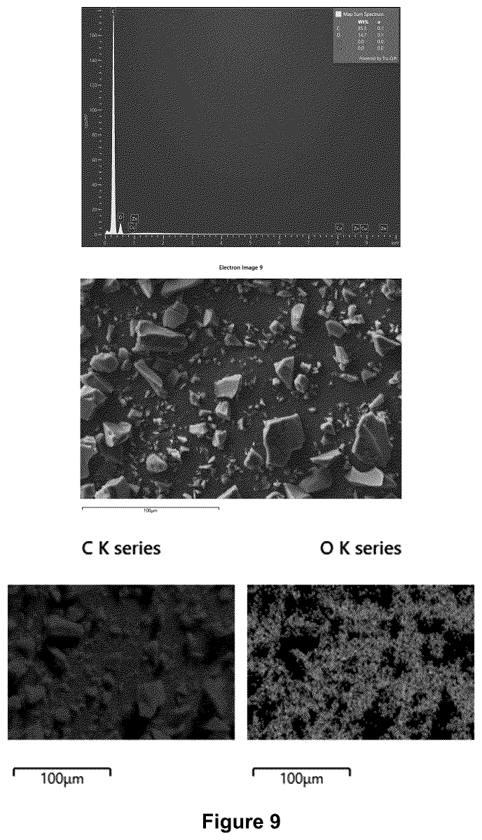

FIGS. 7, 8 and 9 show the EDS spectrum and SEM images and mapping (C, O and Fe in FIGS. 7 and 8, C and O in FIG. 9) respectively of samples G-6, G-7 and G5 prepared as described in Example 2 and measured on carbon tape. As can be seen, all three samples are mainly carbon and various levels of oxygen atoms mainly from the carbon tape support, the remaining elements being absent or only present in minor quantities.

(iii) Thermal Gravimetric Analysis (TGA):

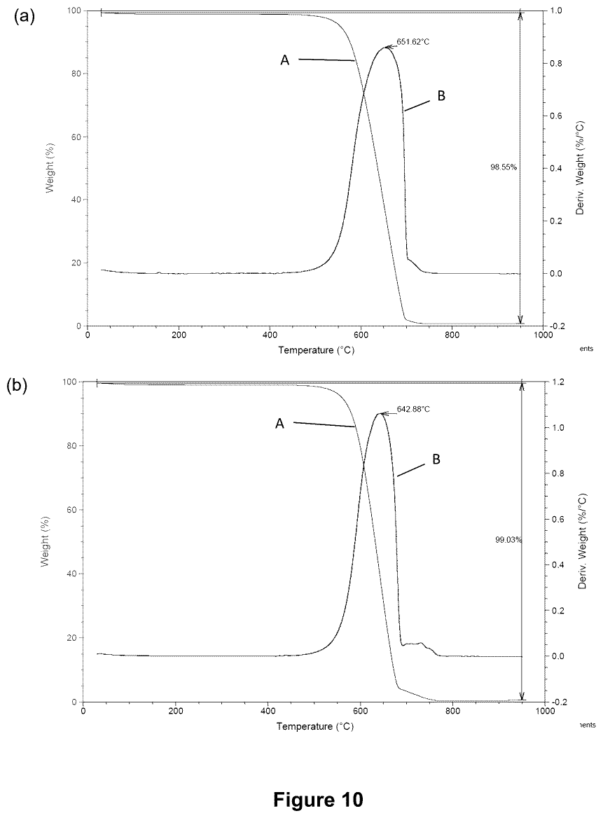

TGA curves of FIGS. 10(a) and 10(b) show the change in weight percentage (left axis) and the first derivative of weight loss (%/° C., right axis) as a function of temperature, which ranged from about room temperature to about 950° C., at a heating rate of about 10° C./minute under synthetic air. The samples analyzed are both G-8 from different batches prepared using the same procedure.

### (iv) Raman Analysis:

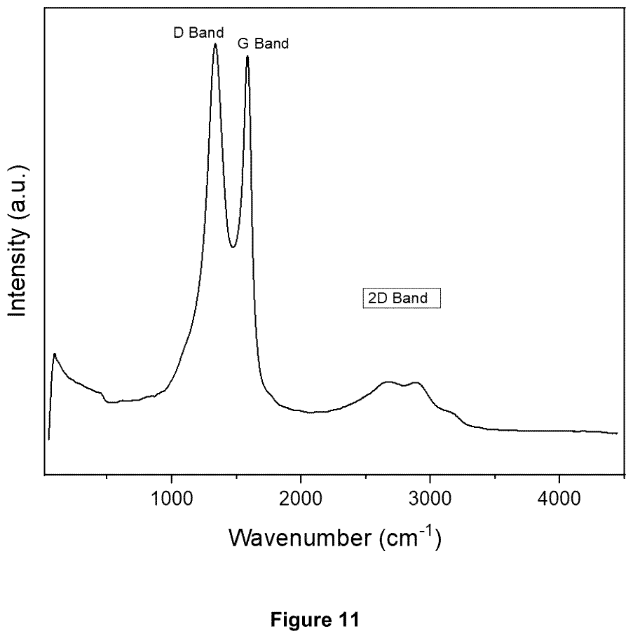

FIG. 11 shows the Raman spectrum of sample G-8 prepared according to Example 2. The results show a D band peak at 1333 to 1400 cm-1, a G band at 1597 to 1600 cm-1, and 2D band splinting peaks at 2659 cm-1 and 2888 cm-1. Also, the results show small peaks between 1700 cm-1 to 2200 cm-1, which are characteristic of TS1 and TS2 and suggest that the graphene has a turbostratic nature.

### (v) Elemental Analysis:

Elemental analysis was performed on sample G-9 and three different milling batches of samples G-10, labelled as G-10(a) to G-10(c). Table 2 details the results obtained.

TABLE 2
Elemental analysis (detection limit and results in μg/g)

| Element | Detection limit | G-9 | G-10(a) | G-10(b) | G-10(c) |
|---|---|---|---|---|---|
| Al | 0.1 | 1.7 | 77.4 | 61.4 | 61.3 |
| As | 0.5 | <0.5 | <0.5 | <0.5 | <0.5 |
| Ca | 0.1 | 34.1 | 96.8 | 89.5 | 87.9 |
| Cd | 0.1 | <0.1 | <0.1 | <0.1 | <0.1 |
| Co | 0.1 | <0.1 | <0.1 | <0.1 | <0.1 |
| Cr | 0.1 | <0.1 | 13.5 | 12.2 | 3.7 |
| Fe | 0.1 | 5.5 | 123 | 540 | 157 |
| K | 0.5 | 2.3 | 44.0 | 26.6 | 21.6 |
| Mn | 0.1 | 0.1 | 1.8 | 5.4 | 1.5 |
| Na | 0.1 | 15.0 | 44.3 | 47.8 | 50.7 |
| P | 0.5 | 5.1 | <0.5 | <0.5 | <0.5 |
| Pb | 0.5 | <0.5 | <0.5 | <0.5 | <0.5 |
| Ti | 0.1 | 0.2 | 2.1 | 1.7 | 2.0 |
| Zr | 0.1 | <0.1 | 380 | 230 | 150 |

Samples G-9 and G-10 were prepared using the same thermal treatment steps but with different micronization methods. As a result, sample G-9, grinded with glass pestle and mortar show a much lower content in most of the elements than for samples G-10(a) to G-10(c), which used zirconia balls and jar (ball milling) and metal ring and pucks (fast milling). It can thus be confirmed that the slight contamination in some elements in the latter would come from the micronization equipment rather than the graphene synthesis process itself.

Numerous modifications could be made to any of the embodiments described above without departing from the scope of the present invention. Any references, patents or scientific literature documents referred to in the present document are incorporated herein by reference in their entirety for all purposes.

1. Process for the preparation of graphene and/or graphite, said process comprising the steps of:
(a) thermally treating a carbon-containing material at a temperature of at most 300° C.;
(b) thermally treating the product from step (a) at a temperature above 700° C. to induce graphitization and produce a graphitized carbon; and
(c) optionally thermally treating the graphitized carbon from step (b) at a temperature within the range of 200° C. to 600° C. in the presence of air to eliminate residual amorphous carbon;
wherein step (b) comprises in situ generation of hydrogen (H₂) and said process excludes injection of additional hydrogen or inert gas; and
wherein said process does not include a chemical pre-treatment of the carbon source and/or a chemical post-treatment of the produced the graphene and/or graphite.

2. The process of claim 1, wherein said carbon-containing material is selected from carbohydrate sources, for instance from biomass, organic oils, petroleum-based oils, waxes, alcohols, resins, gums, or a combination of two or more thereof, preferably said carbon-containing material is a carbohydrate source comprising a monosaccharide, disaccharide, oligosaccharide or polysaccharide, or a mixture of two or more thereof, preferably the carbohydrate source comprises a monosaccharide or disaccharide, or a mixture thereof, or the carbohydrate source comprises an oligosaccharide or polysaccharide, or a mixture thereof.

3. (canceled)

4. (canceled)

5. (canceled)

6. The process of claim 2, wherein said carbohydrate source is fruit peels and processing refuse (e.g. orange peel, pulp, etc.), cereal husks (e.g. rice husks), wood waste, bagasse, wastepaper, recycled cotton fabric, biochar, nut shells, and the like.

7. The process of claim 1, wherein the carbon-containing material further comprises a high carbon material.

8. The process of claim 1, wherein said thermal treatment step (b) is carried out at a temperature within the range of 700° C. to 1400° C., preferably within the range of 800° C. to 1300° C., or preferably within the range of 900° C. to 1200° C., most preferably within the range of 950° C. to 1100° C., e.g. about 1050° C.

9. (canceled)

10. (canceled)

11. (canceled)

12. The process of claim 1, wherein said process further comprises an intermediate thermal treatment carried out at a temperature within the range of 400° C. to 700° C. between steps (a) and (b), preferably within the range of 500° C. to 650° C., more preferably within the range of 500° C. to 600° C.

13. (canceled)

14. (canceled)

15. (canceled)

16. The process of claim 1, wherein said thermal treatment step (b) is carried out under an atmosphere comprising air.

17. The process of claim 1, wherein said thermal treatment step (b) is carried out in a covered vessel wherein said covered vessel is not sealed or wherein said covered vessel is sealed and includes pressure release valves or pressure control means, preferably said covered vessel is not sealed.

18. (canceled)

19. The process of claim 1, wherein said process excludes the addition of a single metal, metal oxide, alloys, and the like.

20. The process of claim 1, wherein said step (a) and/or (b) further comprise the addition of single metals, salt-derivate metals, metal oxides, alloys, metal nanostructures.

21. The process of claim 1, wherein said step (a) is carried out at a temperature within the range of 150° C. to 300° C., preferably 200° C. to 300° C., more preferably 200° C. to 250° C.

22. The process of claim 1, wherein the carbon-containing material comprises a carbohydrate source and said thermal treatment of step (a) comprises drying the carbohydrate source and/or breaking of di-, oligo- and/or polysaccharide chains from the carbohydrate source.

23. The process of claim 1, wherein said step (a) is carried out under an atmosphere comprising air.

24. The process of claim 1, wherein said thermal treatment of step (c) is present, preferably said thermal treatment of step (c) being carried out at a temperature within the range of 200° C. to 350° C.

25. (canceled)

26. The process of claim 1, wherein said content of residual amorphous carbon in the graphitized carbon is less than 5 wt. %, or less than 2 wt. %, or less than 1 wt. % after step (b), and/or said process comprises a carbon conversion from the carbon-containing material to graphene and/or graphite of at least 30 mol %, at least 40 mol %, or at least 50 mol %.

27. The process of claim 1, wherein said process further comprises micronizing the graphene and/or graphite before step (b), after step (b), and/or after step (c) if present.

28. (canceled)

29. The process of claim 1, wherein said graphene has an average particle size or flake length below 20 nm, or between about 0.1 nm and about 10 nm, or between about 1 and about 10 nm, or between about 2 nm and about 5 nm.

30. The process of claim 1, wherein said graphene has a structure comprising nanoflakes, nanoplatelets, carbon shells, or a combination thereof, or a structure comprising nanocones, nanohorns, nanodandelions, nanoribbons, nanopetals, or a combination thereof, preferably comprising nanoflakes or nanoplatelets.

31. (canceled)

32. The process of claim 1, wherein said graphite is synthetic graphite having a structure comprising synthetic graphite platelets or nanoplatelets.

33. The process of claim 1, wherein said graphene comprises monolayer graphene, few-layer graphene (2 to 20 layers), or a combination thereof, and/or said graphene comprises graphene of turbostratic nature.

34. (canceled)

35. The process of claim 1, wherein said graphene and/or graphite has a carbon content of at least 80 mol %, at least 90 mol %, at least 95 mol %, or at least 97 mol %, or at least 98 mol %, or at least 99 mol %, and/or said graphene and/or graphite has a content in Cd and/or Co of less than 0.1 ppm, and/or a content in As and/or Pb of less than 0.5 ppm, and/or a content in Al, Ca, Cr, K, Mn, Na, P and/or Ti of less than 100 ppm, preferably less than 50 ppm, each obtained by elemental analysis of the graphene and/or graphite, and/or said graphene and/or graphite has a content in Cd, Co, Cr, and/or Zr of less than 0.1 ppm, and/or a content in As and/or Pb of less than 0.5 ppm, and/or a content in Al, Fe, K, Mn, P and/or Ti of less than 10 ppm, and/or a content in Ca and/or Na of less than 50 ppm, each obtained by elemental analysis of the graphene and/or graphite.

36. (canceled)

37. (canceled)

38. Graphene and/or graphite prepared by a process as defined in claim 1.

39. Graphene and/or graphite comprising a carbon content of at least 95 mol %, or at least 97 mol %, or at least 98 mol %, or at least 99 mol %, wherein:
said graphene has a structure comprising nanoflakes, nanoplatelets, carbon shells, or a combination thereof, or a structure comprising nanocones, nanohorns, nanodandelions, nanoribbons, nanopetals, or a combination thereof; and/or
said graphite is synthetic graphite having a structure comprising synthetic graphite platelets or nanoplatelets; and/or
said graphene preferably has an average length below 20 nm, or between about 0.1 nm and about 10 nm, or between about 1 and about 10 nm, or between about 2 nm and about 5 nm; and/or
said graphene preferably comprises monolayer graphene, few-layer graphene (2 to 20 layers), or a combination thereof, and/or is at least in part of turbostratic nature; and/or
said graphene and/or graphite has a content in Cd and/or Co of less than 0.1 ppm, and/or a content in As and/or Pb of less than 0.5 ppm, and/or a content in Al, Ca, Cr, K, Mn, Na, P and/or Ti of less than 100 ppm, preferably less than 50 ppm, each obtained by elemental analysis of the graphene and/or graphite; and/or
said graphene and/or graphite has a content in Cd, Co, Cr, and/or Zr of less than 0.1 ppm, and/or a content in As and/or Pb of less than 0.5 ppm, and/or a content in Al, Fe, K, Mn, P and/or Ti of less than 10 ppm, and/or a content in Ca and/or Na of less than 50 ppm, each obtained by elemental analysis of the graphene and/or graphite.

40. (canceled)

41. (canceled)

42. (canceled)

43. (canceled)

44. (canceled)

45. (canceled)

46. (canceled)

47. (canceled)
